(19) United States
(12) Patent Application Publication
(10) Pub. No.: US 2009/0013033 A1
(43) Pub. Date: Jan. 8, 2009

(54) Identifying excessively reciprocal links among web entities

(75) Inventors: Timothy M. Converse, Sunnyvale, CA (US); Priyank Shankar Garg, San Jose, CA (US); Konstantinos Tsioutsiouliklis, San Jose, CA (US)

Correspondence Address: HICKMAN PALERMO TRUONG & BECKER LLP/Yahoo! Inc., 2055 Gateway Place, Suite 550, San Jose, CA, 95110-1083, US

(73) Assignee: Yahoo! Inc.

(21) Appl. No.: 11/825,392

(22) Filed: Jul. 6, 2007

(51) Int. Cl. G06F 15/16

(52) U.S. Cl. 709/203

(57) ABSTRACT

A method for identifying reciprocal links is provided. At a particular host, the set of hosts which link to the particular host and the set of hosts to which the particular host links are determined. The intersection and union of the two sets of hosts are also determined, and the sizes of the intersection and union are calculated. The concentration of reciprocal links at the particular host is calculated based on the sizes of the intersection and union. A ratio of the intersection size to the union size is used to determine the concentration of reciprocal links. The particular host's rank in a list of ranked search results may be changed as a result of identification of a high concentration of reciprocal links.

### CROSS-REFERENCES TO RELATED APPLICATIONS

The present invention is related to U.S. patent application Ser. No. 11/198,471, filed Aug. 4, 2005 titled “Link-Based Spam Detection” to Berkhin, et al. and U.S. patent application Ser. No. 11/350,967, filed Feb. 8, 2006, titled “Using Exceptional Changes in Webgraph Snapshots Over Time For Internet Entity Marking” to Tsioutsiouliklis, et al., both assigned to Yahoo, Inc. in Sunnyvale, Calif., and both of which are incorporated by reference herein.

### FIELD OF THE INVENTION

The present invention relates to search engines and, more specifically, to a technique for automatically identifying websites whose ranking attributes might have been artificially inflated.

### BACKGROUND

Search engines that enable computer users to obtain references to web pages that contain one or more specified words are now commonplace. Typically, a user can access a search engine by directing a web browser to a search engine “portal” web page. The portal page usually contains a text entry field and a button control. The user can initiate a search for web pages that contain specified query terms by typing those query terms into the text entry field and then activating the button control. When the button control is activated, the query terms are sent to the search engine, which typically returns, to the user's web browser, a dynamically generated web page that contains a list of references to other web pages that contain or are related to the query terms.

Usually, such a list of references will be ranked and sorted based on some criteria prior to being returned to the user's web browser. Web page authors are often aware of the criteria that a search engine will use to rank and sort references to web pages. Because web page authors want references to their web pages to be presented to users earlier and higher than other references in lists of search results, some web page authors are tempted to artificially manipulate their web pages, or some other aspect of the network in which their web pages occur, in order to artificially inflate the rankings of references to their web pages within lists of search results.

For example, if a search engine ranks a web page based on the value of some attribute of the web page, then the web page's author may seek to alter the value of that attribute of the web page manually so that the value becomes unnaturally inflated. For example, a web page author might fill his web page with hidden metadata that contains words that are often searched for, but which have little or nothing to do with the actual visual content of the web page. In another example, a web page author adds to a web page many incoming hyperlinks, also called inlinks, based on the observation that web pages more frequently referenced by other web pages are generally considered by search engines as being of higher relevance. One method used by web page authors to increase the number of inlinks in web pages is to create web pages with “reciprocal links,” where two web pages both link to each other, resulting in an increased number of inlinks for each reciprocally linked web page.

When web page authors engage in these tactics, the perceived effectiveness of the search engine is reduced. Spurious references to web pages which are not useful for users and are meant to boost search rankings sometimes push poorer results above web pages that users have previously found interesting or valuable for legitimate reasons. Thus, it is in the interests of those who maintain the search engine to “weed out,” from search results, references to web pages that are known to have been artificially manipulated in the manner discussed above.

Therefore, there is a need for an automated way of identifying web pages that are likely to have been manipulated in a manner that artificially inflates the rankings of those web pages within lists of search results. Specifically, there is a need for an automated way of identifying web pages whose numbers of inlinks have been artificially boosted by reciprocal links in an effort to achieve higher rankings for those web pages.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram that illustrates an example of a graph of a node and its inlinking nodes and outlinks.

FIG. 2 is a diagram that illustrates another example of a graph of a node and its inlinking nodes and outlinks.

FIG. 3 is a diagram that illustrates an example of a graph of a cluster of nodes which are linked to each other.

FIG. 4 is a flow diagram that illustrates an example of a technique for automatically identifying suspicious web pages, according to an embodiment of the invention.

FIG. 5 is a diagram that illustrates an example of a graph which contains nodes with two-level reciprocal links.

FIG. 6 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Techniques are provided through which “suspicious” web pages (or other entities) within a set of web pages (or other entities) may be identified automatically. A “suspicious” web page (or other entity) is a web page (or other entity) which possesses attributes or characteristics that tend to indicate that the web page (or other entity) was manipulated in a way that would artificially inflate the position or ranking of a reference to the web page (or other entity) within a list of ranked search results returned by a search engine, such as the Internet search engine provided by Yahoo!. Web pages are not the only entities that may be identified as “suspicious.” Other entities that may be identified as “suspicious” include hosts and domains, among others.

According to one technique, known web pages are represented as nodes within a graph. Wherever one web page contains a link to another web page, that link is represented in the graph by a directed edge. A directed edge leads from one node, which represents the web page containing the link, to another node, which represents the web page to which the link refers. The “outlinks” of a web page are web pages to which the web page links. The “inlinks” of a web page are web pages which link to the web page. A web page contains a “reciprocal link” when one of its “outlinks” is also one of its “inlinks”. That is, a reciprocal link exists when a web page links to another web page which also links back to the web page.

According to one technique, the concentration of reciprocal links contained in a web page is determined based on the sizes of the union and intersection of the web page's inlinks and outlinks. The union of a web page's inlinks and outlinks is the set of web pages which are either an inlink or an outlink of the web page. The intersection of a web page's inlinks and outlinks is the set of web pages which are both an inlink and an outlink of the web page. The size of the union is simply the number of web pages in the union, and the size of the intersection is the number of web pages in the intersection.

The concentration of reciprocal links contained in a web page may be indicated by the ratio of the size of the intersection to the size of the union of the inlinks and outlinks of the web page. The closer the ratio is to 1, the higher the concentration of reciprocal links. For example, in a web page that has ten links to ten different web pages, each of which also has a link back to the web page, the ten web pages are both inlinks and outlinks. In this case, every inlink in the web page is also a reciprocal link, the highest possible concentration of reciprocal links. Indeed, the union and intersection of inlinks and outlinks in this example, which comprises the ten web pages, is the same. Consequently, the size of the union and the size of the intersection, both 10, are also the same, resulting in a ratio of 1.

Web pages which have a high concentration of reciprocal links may be “suspicious” web pages whose numbers of inlinks have been artificially boosted to improve rankings in a list of results generated by a search engine. These web pages can be identified by setting a threshold value for the ratio of the intersection size to the union size, and marking web pages whose ratios exceed the threshold value as suspicious web pages which may merit further investigation or action.

According to another technique, a web page is marked as “suspicious” based on properties of the union and intersection sets of the web page's inlinks and outlinks other than the simple ratio of the size of the intersection to the size of the union.

In yet another technique, the union and intersections of multiple web pages' inlinks and outlinks are examined together to determine whether these web pages should be marked as “suspicious”.

The techniques described above can also be applied to entities other than web pages, such as sites and domains. These techniques, and variations and extensions of these techniques, are described in greater detail below.

### EXAMPLES OF RECIPROCAL LINKS

As is discussed above, a network of interlinked web pages may be represented as a graph. In one embodiment of the invention, the nodes in the graph correspond to the web pages in the network, and the directed edges between the nodes in the graph correspond to links between the web pages. In one embodiment of the invention, web pages are automatically discovered and indexed by a “web crawler,” which is a computer program that continuously and automatically traverses hyperlinks between Internet-accessible web pages, thereby sometimes discovering web pages that the web crawler had not previously visited. Information gathered and stored by the web crawler indicates how the discovered web pages are linked to each other.

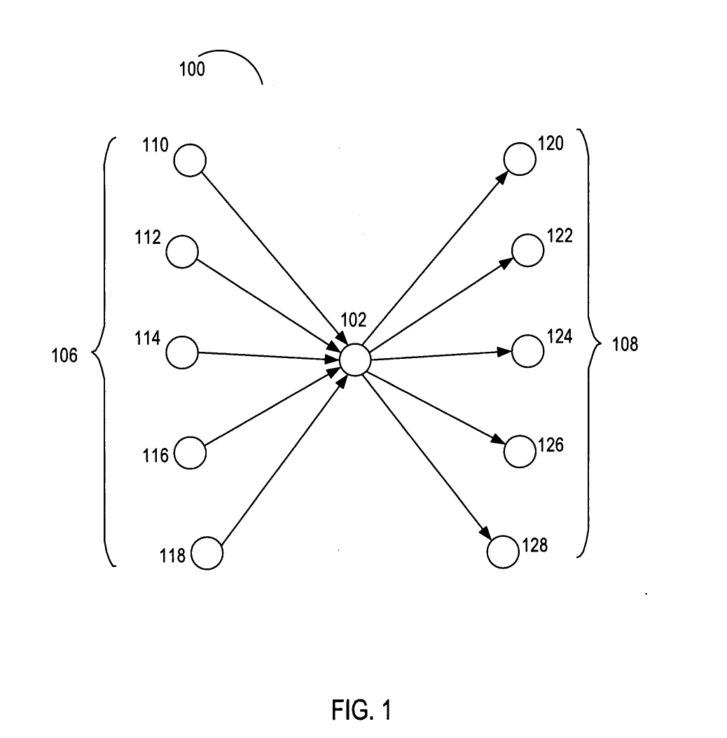

FIG. 1 is a diagram that illustrates an example of a node in a graph and the nodes to which it is linked. Node 102 is a node in graph 100. Node 102 has five inlinks (nodes 110, 112, 114, 116, and 118; collectively 106). Each of the nodes 106 has at least one link to node 102. Node 102 also has five outlinks (nodes 120, 122, 134, 126, and 128; collectively 108). Node 102 has at least one link pointing to each node in nodes 108. In this example, none of the inlinks 106 overlap with the outlinks nodes 108. In other words, node 102's inlinks are completely distinct from its outlinks.

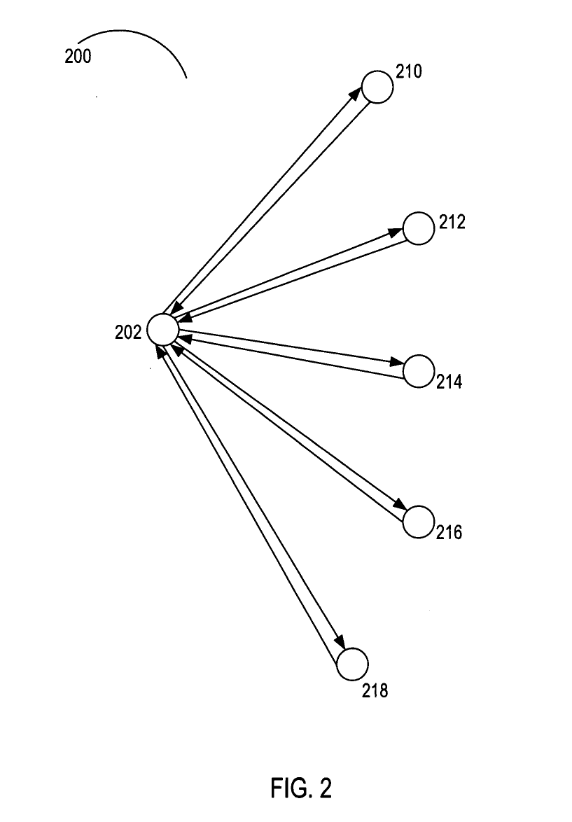

FIG. 2 is a diagram that illustrates another example of a node in a graph and the nodes to which it is linked. Node 202 is a node in graph 200. Node 202 also has five inlinking nodes and five outlinks. In this example, however, the five inlinks and the five outlinks are the same and consist of nodes 210, 212, 214, 216, and 218. In other words, every node to which node 202 links also links back to node 202. Node 202's inlinks and outlinks completely overlap with each other.

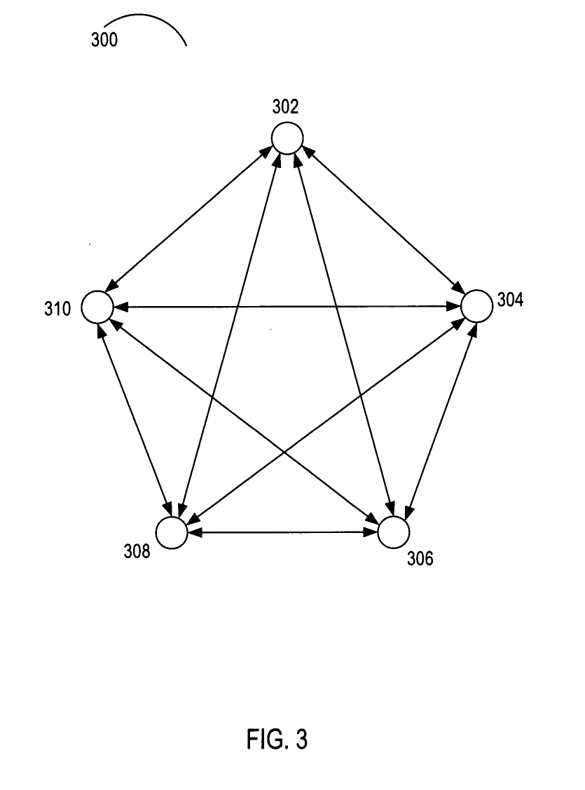

FIG. 1 and FIG. 2 focus on a single node and its inlinks and outlinks. FIG. 3 is a diagram that illustrates an example of a group of nodes which are linked to each other. The double-ended arrows in the links in FIG. 3 indicate that the links are reciprocal—each node to which a particular node links also links back to the particular node itself. Here, all five of the nodes (nodes 302, 304, 306, 308, and 310) have reciprocal links with every other node in the web graph 300. This configuration may be used by a web page author who wishes to boost the number of inlinks to his web pages. For example, nodes 302, 304, 306, 308, and 310 may each be a web page that contains links to all the other web pages in the web graph 300, resulting in each web page containing four artificial inlinks. The group of nodes in FIG. 3 may be expanded to contain a larger number of nodes, resulting in each web page containing a higher number of inlinks. Furthermore, the nodes in FIG. 3 may represent sites or domains, and web page authors may similarly configure sites or domains with reciprocal links to inflate the number of inlinks to particular sites or domains.

### Identifying Suspicious Web Pages

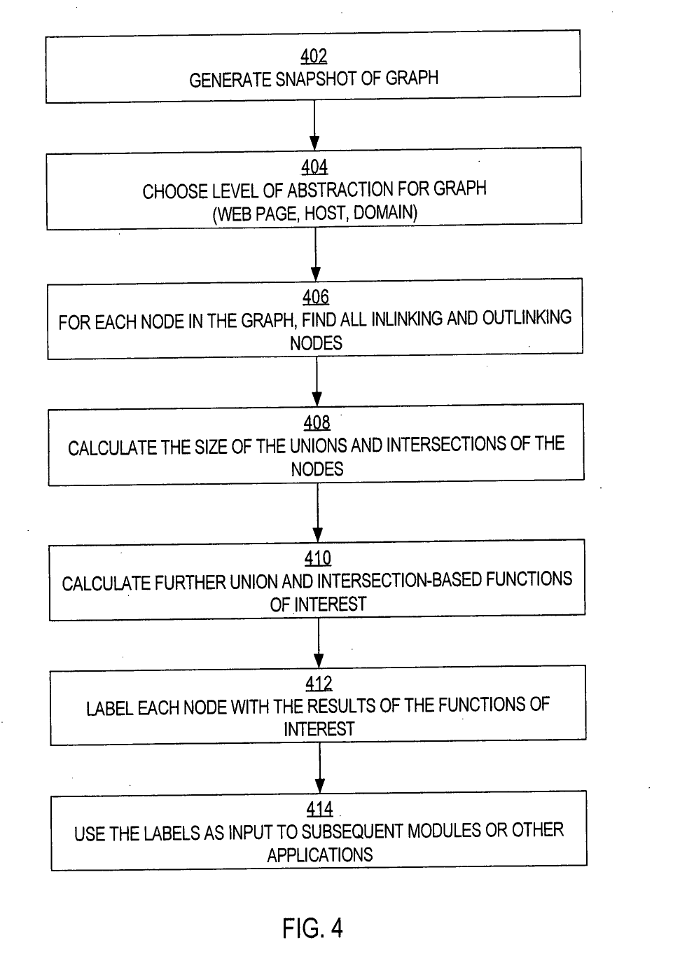

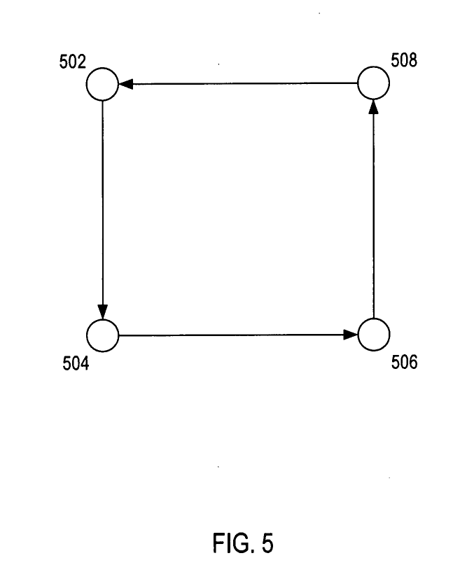

FIG. 4 is a flow diagram that illustrates an example of a technique for automatically identifying suspicious web pages, according to an embodiment of the invention. The technique described is merely one embodiment of the invention. Some other alternative embodiments of the invention are described further below. The technique, or portions thereof, may be performed, for example, by one or more processes executing on a computer system such as that described below with reference to FIG. 5.

In block 402, a snapshot, which represents a state of a network of interlinked pages, is generated. This snapshot may be in the form of a graph with nodes and directed edges, as described above. In one embodiment, the nodes of this graph may represent web pages, and the directed edges may represent how the web pages are linked to each other, in which case the graph is called a “web graph”. According to other embodiments of the invention, the nodes of a graph may alternatively represent entities other than web pages. For example, at higher levels of abstraction, the nodes may represent hosts on which multiple web pages may be hosted (in which case the graph is called a “host graph”) or Internet domains with which multiple hosts may be associated (in which case the graph is called a “domain graph”).

Accordingly, in block 404, a level of abstraction for the graph is chosen. If the level of abstraction is web pages, then each node in the graph represents a web page. If the level of abstraction is hosts, then each node in the graph represents a host, which may contain multiple web pages. Similarly, if the level of abstraction is domains, then each node in the graph represents a domain, which may contain multiple hosts, which in turn may contain multiple web pages. This discussion will focus on the web page level of abstraction, and the graph will hereinafter be referred to as a “web graph”. However, the techniques discussed with regards to a web graph may similarly be applied to a “host graph,” a “domain graph,” or a graph representing any other type of abstraction.

In block 406, the inlinks and outlinks of each node in the web graph are found. As discussed above, all nodes which have links to a particular node are the inlinks of that particular node. All nodes to which a particular node has links to are the outlinks of that particular node. Referring back to FIG. 1, node 102 has inlinks 110, 112, 114, 116, and 118, and outlinks 120, 122, 124, 126, and 128. As the web page has been selected as the level of abstraction in this example, each node in block 406 is a web page. Accordingly, in this example, a web page's inlinks are other web pages which link to the web page, and a web page's outlinks are other web pages to which the web page links.

In block 408, the sizes of the unions and intersections of a node's inlinks and outlinks are calculated for each node in the web graph. The union of a particular node's inlinks and outlinks (hereinafter, “union”) is the set of nodes which are either an inlink or an outlink of the particular node. For example, in FIG. 1, the union of node 102 comprises the ten nodes 110, 112, 114, 116, 118, 120, 122, 124, 126, and 128. In another example, in FIG. 2, the union of node 202 comprises the five nodes 210, 212, 214, 216, and 218.

The intersection of a particular node's inlinks and outlinks (hereinafter, “intersection”) is the set of nodes which are both an inlink and an outlink of the particular node. In FIG. 1, the intersection of node 102 would be a null set because no node in FIG. 1 is both an inlink and an outlink of node 102. In contrast, in FIG. 2, the intersection of node 202 comprises five nodes 210, 212, 214, 216, and 218 because each of these nodes is both an inlink and an outlink of node 202.

The size of a set of nodes is simply the number of nodes in that set. Accordingly, the size of a union is the number of nodes in the union, and the size of an intersection is the number of nodes in the intersection. For example, in FIG. 1, the size of the union of inlinks and outlinks of node 102 is 10. The size of the intersection of inlinks and outlinks of node 102 is 0 because the intersection is a null set. In FIG. 2, the sizes of the union and intersection of the inlinks and outlinks of node 202 are both 5, because each inlink is also an outlink. Thus, in block 408, these union and intersection size calculations are performed for each node in the web graph.

In block 410, the sizes of the unions and intersections of inlinks and outlinks for the nodes in a web graph are used to calculate further functions of interest. The calculated results of these functions of interest indicate the nature and amount of reciprocal links in a web graph. As discussed above, a high percentage of reciprocal links in a web page's inlinks indicate that the web page may have been manipulated to artificially boost the web page's rankings in a search engine results list. In one technique, the function of interest is the ratio of the size of the intersection to the size of the union for a particular node. This ratio function of interest estimates how many inlinks of the particular nodes are also reciprocal links. For node 102 in FIG. 1, for example, this ratio is 0 because the size of the intersection for node 102 is 0. A ratio of 0 for a particular node indicates that none of the particular node's inlinks are reciprocal links. In other words, the particular node does not link to any nodes which also link back to the particular node. Indeed, for node 102 in FIG. 1, each inlink is distinct from each outlink. FIG. 2, on the other hand, illustrates the case where all of a node's inlinks are reciprocal links. In FIG. 2, each node that links to node 202 is also linked from node 202. The intersection and union for node 202 are the same, and these sets each have a size of 5. The ratio for node 202 is 1, which indicates that all of node 202's inlinks are reciprocal links, as illustrated in FIG. 2. These two examples illustrate that the ratio of intersection size to union size may range anywhere from 0 to 1 for a particular node. Accordingly, a threshold value can be set where a node with a ratio above the threshold value, indicating that a certain percentage of its links are reciprocal links, is marked as a suspicious web page. This is further discussed below with regard to block 414.

The ratio function just described is only one example of any number of functions that can be based on the sizes of unions and intersections. Other embodiments may employ different functions of interest. For example, in one embodiment, a function of interest can be the ratio of a node's intersection size to the node's union size, multiplied by the logarithm of the union size. The value of this function of interest increases when the union size is large, which indicates that the node is located in a larger, more widely linked web graph. In such a web graph, even a relatively small percentage of inlinks which are reciprocal links may indicate artificial manipulations. Thus, if a node is marked suspicious based on whether the node's function of interest surpasses a certain threshold value, then the function of interest in this example will mark nodes with smaller percentages of reciprocal links in larger web graphs suspicious, as well as nodes with larger percentages of reciprocal links in smaller web graphs. As discussed above, many other functions of interest based on a node's intersection size and union size may be calculated.

In block 412, each node in the web graph is labeled with that node's value of the function of interest. For example, if the function of interest is the ratio of a node's intersection size to its union size, then node 102 in FIG. 1 will be labeled with value 0 and node 202 in FIG. 2 will be labeled with the value 1.

Finally, in block 414, these labels are used as input to subsequent modules or other applications. As discussed above, one of these modules or applications may set a threshold value for a ratio, and if a node's label exceeds the threshold value, then node is marked as suspicious and may be automatically demoted in a ranking of search results.

As discussed above, the foregoing technique is but one of many possible variant embodiments of the invention. Some alternative embodiments of the invention are discussed below.

### Identifying Suspicious Hosts and Domains

As discussed above, according to some embodiments of the invention, the nodes of a graph may represent entities other than web pages, such as hosts and domains.

Usually, each Internet-accessible resource (e.g., web page) is associated with a Uniform Resource Locator (URL) that is unique to that resource. Each URL comprises a “host part” that identifies a host for the resource, and a “domain part” that identifies a domain for the resource. The domain part typically comprises both the “top-level domain” of the URL (e.g., “com,” “org.”, “gov,” etc.) and the word or phrase that immediately precedes the top-level domain in the URL. For example, in the URL “www.yahoo.com,” the domain part is “yahoo.com.” The host part typically comprises the entire part of the URL that precedes the first single (i.e., not double) “/” symbol in the URL, excluding any instance of “http://.” For example, in the URL “http://images.search.yahoo.com/search,” the host part is “images.search.yahoo.com,” while the domain part is merely “yahoo.com.”

In a host graph, each node represents a separate host. Directed edges between the nodes represent links between pages hosted on the hosts represented by those nodes. In a domain graph, each node represents a separate domain. Directed edges between the nodes represent links between pages hosted on the hosts included within the domains represented by those nodes.

Similar to the way that suspicious web pages can be identified using techniques described above, suspicious hosts and domains also may be identified. In block 404 in FIG. 4, discussed above, the host or domain level of abstraction may be selected. If the host level of abstraction is selected, for example, then the graph will be a host graph where each node in the graph represents a host. An inlink to a particular node or host in a host graph is another node or host which contains at least one web page which has at least one link to at least one web page in the particular node or host. An outlink of a particular node or host is another node or host which contains at least one web page to which at least one web page in the particular node or host links. Inlinks and outlinks for a domain graph may be similarly defined. Blocks 406 through 414 in FIG. 4 can be carried out for both host graphs and domain graphs to identify suspicious hosts or domains.

Hosts, domains, and web pages are not the only entities that can be automatically scrutinized using the techniques described herein. Some of the other possible entities that can be represented by nodes in the kind of graph described above are web sites, Internet Protocol addresses, autonomous systems, top-level domains, logical sites, etc. Regardless of the level of abstraction of the entities in the graph, the graph can be derived from information collected by an automated web crawler mechanism.

### Identifying Multi-Level Reciprocal Links

According to another embodiment, multi-level reciprocal links may be identified using similar techniques. FIG. 5 illustrates a graph with nodes containing multi-level reciprocal links. Node 502 links to node 504, which in turns links to node 506. Node 506 links to node 508, which then links back to node 502. For each of the four nodes 502, 504, 506, and 508, the inlinks and outlinks do not overlap. In other words, none of these nodes contains reciprocal links as discussed above. However, these nodes contain multi-level reciprocal links-reciprocal links with at least one intermediate node. For example, node 502 contains a two-level reciprocal link with node 506. Node 506 is an inlink to node 508, which is in turn an inlink to node 502. Node 506 is also an outlink of node 504, which is in turn an outlink of node 502. Similarly, nodes 504 and 508 contain two-level reciprocal links with each other.

If the flow diagram in FIG. 4 is executed with respect to these nodes using the ratio of intersection size to union size as the function of interest, none of these nodes would be marked suspicious because their function values are all 0. However, a web page author may create multi-level reciprocal links such as those in FIG. 5 to artificially create inlinks. Thus, there is a need to identify such multi-level reciprocal links.

In one technique, block 406 in FIG. 4 is modified to identify all inlinks and outlinks of each node up to a certain preset level of multi-level inlinks and outlinks. For example, if the preset level is two, then all single-level and two-level inlinks and outlinks are identified. Subsequently, in block 408, the unions and intersections are calculated based on all the identified inlinks and outlinks. For example, for node 502 in FIG. 5, if the preset level is two, then nodes 504 and 506 are identified as outlinks, and nodes 506 and 508 are identified as inlinks. The union of inlinks and outlinks for node 502 is nodes 504, 506, and 508, and the union size is 3. The intersection of inlinks and outlinks for node 502 is node 506, and the intersection size is 1. If the function of interest is the ratio of intersection size to union size, then the function value for node 502 is one-third. If, furthermore, in block 414, a module or application marks nodes with function values above a certain threshold value as suspicious, and if this threshold value is less than one-third, then node 502 is marked as suspicious. By expanding the scope of inlinks and outlinks to nodes which may be linked to a particular node in a more indirect manner, this technique identifies suspicious web pages, sites, or domains which may have been boosted with artificial inlinks via indirect reciprocal links.

### Identifying Suspicious Clusters

In another technique, clusters of nodes are identified as suspicious and marked for further actions. The techniques discussed herein so far identify individual nodes as suspicious. However, web page authors may construct entire clusters of nodes which link to each other reciprocally to artificially boost the nodes' number of inlinks. Although the techniques discussed above may identify the nodes in such clusters as suspicious based on these nodes' individual functions of interest, a technique which examines the nodes' functions of interest as a group helps to further identify suspicious clusters.

An example will help to illustrate this technique. A web page author creates five web pages, where each of the five web pages only has two inlinks. The web page author seeks to boost the number of inlinks of these web pages, and creates reciprocal links among the five web pages in a configuration illustrated in FIG. 3. Now, each of the five web pages has four additional inlinks, and the web page author has successfully but artificially boosted the number of inlinks for his web pages. In order to thwart the author, the method illustrated in the flow diagram in FIG. 4 is executed with respect to these nodes. In block 408, the unions and intersections of these nodes are calculated to be six and four, respectively, for each node. The function of interest in this example is the ratio of intersection to union, and in block 410 this ratio is calculated to be two-thirds for each node. In block 412, each node is labeled with two-thirds. In block 414, according to the techniques discussed so far, each node's function of interest is examined for suspiciousness, such as by comparing the function of interest with a specified threshold. In this technique, however, the nodes' functions of interest are examined together. In the current example, block 414 examines a particular node's function of interest and the functions of interest of the nodes which are linked to the particular node. This is done to detect any cases where closely linked nodes have similar functions of interest, because similar functions of interest among closely linked nodes indicate a cluster of artificially created reciprocal links. In this case, the five web pages are identified as having very similar functions of interest (i.e., two-thirds) and are therefore all marked suspicious.

Although this discussion has focused on the example of web pages, similar techniques may be applied to clusters of sites, domains, or any other level of abstraction.

### Actions Taken with Respect to Suspicious Entities

Once one or more suspicious entities (e.g., web pages, hosts, domains, etc.) have been automatically identified, a variety of actions may be taken relative to those entities. It may be that some of those entities have a high percentage of reciprocal links for legitimate reasons, and not because that web page's author has engaged in any nefarious activity. For example, a particular web page may have many reciprocal links with a group of web pages because these web pages discuss the same subject matter in a complementary fashion and the web page authors have found it expedient for those web pages to refer to each other. In another example, two groups of web pages refer to each other reciprocally because those groups belong to two company web sites where the companies are part of the same conglomerate.

Therefore, in some embodiments of the invention, the identities of suspicious entities are logged for further investigation. Such further investigation may be by human investigators, other automated investigating mechanisms—such as mechanisms that implement machine-learning principles—or some combination of these.

In some embodiments of the invention, the closer the value of an entity's function of interest is to the specified threshold for that function of interest, the less uncertainty there is that the value has been artificially inflated. Thus, a “degree of confidence” may be associated with the identification of each entity as either suspicious or not suspicious. In one embodiment of the invention, entities which have been identified as being suspicious with only a low degree of confidence are marked for further evaluation by another mechanism (e.g., human or artificial intelligence). In contrast, references to entities which have been identified as being suspicious with a high degree of confidence may be automatically excluded from future lists of search results without further investigation, according to one embodiment of the invention.

In another embodiment of the invention, entities which have been identified as suspicious may be automatically demoted in a list of ranked search results. Alternatively, an entity's ranking in a list of ranked search results may also be affected by the “degree of confidence” so that a lower degree of confidence results in a lower ranking.

In one embodiment of the invention, a “white list” of web pages, hosts, domains, and/or other entities is maintained. For example, search engine administrators may create and maintain a list of domains that are known to be popular and legitimate (e.g., the domain “yahoo.com”). In such an embodiment of the invention, all entities that are on the “white list,” and all sub-entities that are hosted on or contained within entities that are on the “white list,” are automatically excluded from identification as suspicious entities.

In one embodiment of the invention, references to entities that have been identified as being suspicious are not automatically excluded from future lists of search results, nor are the rankings of such references within future lists of search results automatically adjusted. Instead, in one embodiment of the invention, entities that have been identified as being suspicious are automatically further evaluated based on criteria other than those that were initially used to identify those entities as suspicious entities. For example, a web page that has been deemed to be suspicious may be input into a program that automatically searches for words, in that web page, which are usually found in artificially manipulated web pages (e.g., words dealing with pornographic web sites and/or words dealing with prescription drugs). Such a program may make a further determination, based on an automatic evaluation of the content of the web page, as to whether that web page still should be considered a suspicious web page, and whether references to that web page should be excluded from, or have their rankings adjusted within, lists of search results. In contrast, web pages that were not initially deemed to be suspicious do not need to be input into such a program.

### Machine Learning Techniques

Using the techniques discussed above, suspicious web pages may be automatically identified based on functions of interest that are based on the intersection size and union size of a web page's inlinks and outlinks.

In one embodiment of the invention, once such a set of suspicious entities has been formed, those suspicious entities, or portions thereof, may be provided as “training data” for a machine-learning mechanism. Such a machine-learning mechanism may receive a set of suspicious web pages, for example, and automatically identify features that those suspicious web pages tend to have in common. As a result, the machine-learning mechanism “learns” that suspicious web pages tend to have certain features.

Once the machine-learning mechanism has “learned” the features that suspicious web pages or other entities tend to have, the machine-learning mechanism can evaluate additional entities to determine whether those entities also possess the features. The machine-learning entity can determine, based on whether other entities also possess the features, whether those other entities are also suspicious entities. Thus, the machine-learning entity becomes an “automatic classifier.” Based on whether those other entities also possess the features, the machine-learning entity can take appropriate action relative to those entities (e.g., excluding references to those entities from lists of search results, etc.).

A machine-learning mechanism also may be supplied a set of web page or other entities that are known to be legitimate. The machine-learning mechanism may be informed that this set represents a legitimate set. The machine-learning mechanism may automatically determine usually shared features of these entities, and, based on whether other entities possess these features, prevent other entities that possess these features from being treated as suspicious entities. Thus, embodiments of the invention may implement machine-learning mechanisms to continuously refine definitions of high-quality web pages and other entities so that such high-quality web pages and other entities can be automatically identified with greater precision and accuracy. Such embodiments of the invention are useful even in the absence of the growth of suspicious entities.

### Hardware Overview

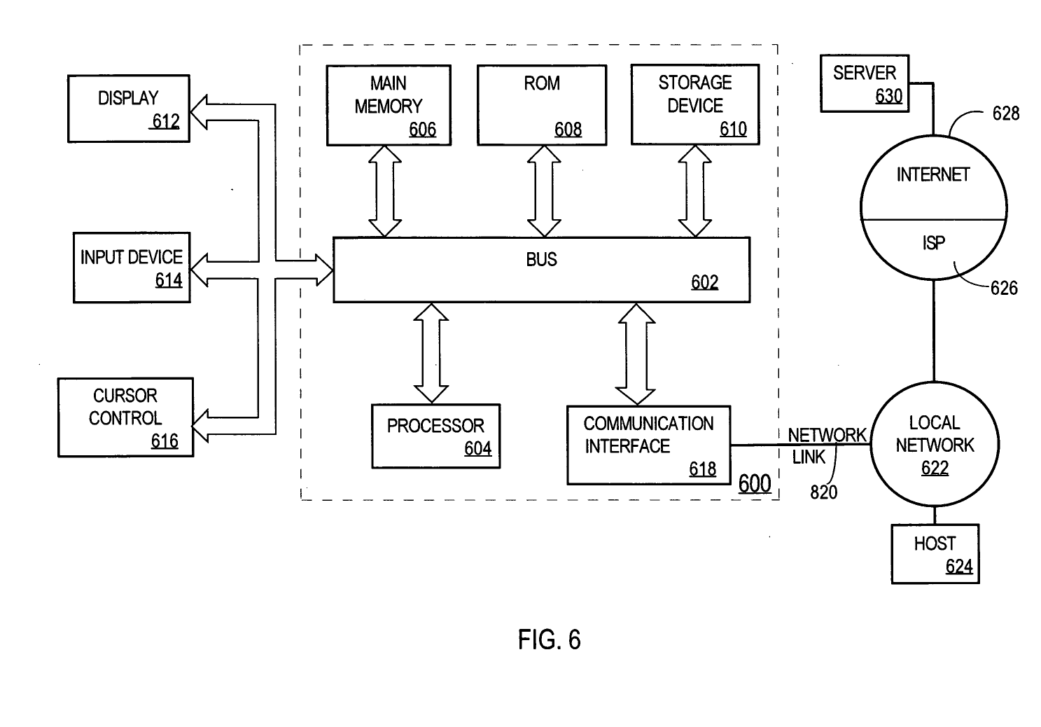

FIG. 6 is a block diagram that illustrates a computer system 600 upon which an embodiment of the invention may be implemented. Computer system 600 includes a bus 602 or other communication mechanism for communicating information, and a processor 604 coupled with bus 602 for processing information. Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

The invention is related to the use of computer system 600 for implementing the techniques described herein. According to one embodiment of the invention, those techniques are performed by computer system 600 in response to processor 604 executing one or more sequences of one or more instructions contained in main memory 606. Such instructions may be read into main memory 606 from another machine-readable medium, such as storage device 610. Execution of the sequences of instructions contained in main memory 606 causes processor 604 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 600, various machine-readable media are involved, for example, in providing instructions to processor 604 for execution. Such a medium may take many forms, including but not limited to, non-volatile media, volatile media, and transmission media. Non-volatile media includes, for example, optical or magnetic disks, such as storage device 610. Volatile media includes dynamic memory, such as main memory 606. Transmission media includes coaxial cables, copper wire and fiber optics, including the wires that comprise bus 602. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 604 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are exemplary forms of carrier waves transporting the information.

Computer system 600 can send messages and receive data, including program code, through the network(s), network link 620 and communication interface 618. In the Internet example, a server 630 might transmit a requested code for an application program through Internet 628, ISP 626, local network 622 and communication interface 518.

The received code may be executed by processor 604 as it is received, and/or stored in storage device 610, or other non-volatile storage for later execution. In this manner, computer system 600 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for identifying reciprocal links comprising:
determining, for a particular host, a value that is based at least in part on both (a) an intersection of (i) a first set of hosts and (ii) a second set of hosts and (b) a union of (i) the first set of hosts and (ii) the second set of hosts; and
presenting a list of ranked search results in which a rank of at least one web page that is hosted by the particular host is based at least in part on the value.

2. The method of claim 1, wherein:
the first set of hosts consists of hosts other than the particular host that host at least one web page that links to at least one web page that is hosted by the particular host; and
the second set of hosts consists of hosts other than the particular host that host at least one web page to which at least one web page that is hosted by the particular host links.

3. The method of claim 1, wherein:
the first set of hosts consists of hosts other than the particular host that host at least one web page that links to at least one web page that is hosted by a particular host, either directly or indirectly through a first maximum number of intermediate web pages; and
the second set of hosts consists of hosts other than the particular host that host at least one web page to which at least one web page that is hosted by the particular host links, either directly or indirectly through a second maximum number of intermediate web pages.

4. The method of claim 1, wherein determining the value comprises dividing a size of the first set by a size of the second set.

5. The method of claim 1, wherein determining the value comprises dividing a size of the first set by a size of the second set and multiplying by a logarithm of the second set.

6. The method of claim 1, wherein presenting the list of ranked search results comprises comparing the value to a threshold value and changing the rank of the at least one web page on whether the value is greater than the threshold value.

7. The method of claim 6, wherein changing the rank comprises removing the at least one web page from the list of ranked search results if the value is greater than the threshold value.

8. The method of claim 6, wherein changing the rank comprises demoting the rank of the at least one web page.

9. The method of claim 6, wherein changing the rank comprises demoting the rank of the at least one web page by an amount proportional to how much the value is greater than the threshold value.

10. A computer-implemented method comprising:
for each host in a plurality of hosts,
determining, for the each host, a value that is based at least in part on both (a) an intersection of (i) a first set of hosts and (ii) a second set of hosts and (b) a union of (i) a first set of hosts and (ii) the second set of hosts;
associating the each host with the value wherein the step of associating comprises storing the value in a computer-readable medium; and
presenting a list of ranked search results in which a rank of at least one web page that is hosted by the each host is based at least in part on the value associated with the each host and values associated with other hosts in the plurality of hosts.

11. The method of claim 10 wherein presenting the list of ranked search results comprises comparing the value associated with the each host with values associated with other hosts in the plurality of hosts and changing the rank of the at least one web page based on how similar the value associated with the each host is with values associated with other hosts in the plurality of hosts.

12. A computer-readable medium carrying one or more sequences of instructions for identifying reciprocal links, which instructions, when executed by one or more processors, cause the one or more processors to carry out the steps of:
determining, for a particular host, a value that is based at least in part on both (a) an intersection of (i) a first set of hosts and (ii) a second set of hosts and (b) a union of (i) the first set of hosts and (ii) the second set of hosts; and
presenting a list of ranked search results in which a rank of at least one web page that is hosted by the particular host is based at least in part on the value.

13. The computer-readable medium as recited in claim 12, wherein:
the first set of hosts consists of hosts other than the particular host that host at least one web page that links to at least one web page that is hosted by the particular host; and
the second set of hosts consists of hosts other than the particular host that host at least one web page to which at least one web page that is hosted by the particular host links.

14. The computer-readable medium as recited in claim 12, wherein:
the first set of hosts consists of hosts other than the particular host that host at least one web page that links to at least one web page that is hosted by a particular host, either directly or indirectly through a first maximum number of intermediate web pages; and
the second set of hosts consists of hosts other than the particular host that host at least one web page to which at least one web page that is hosted by the particular host links, either directly or indirectly through a second maximum number of intermediate web pages.

15. The computer-readable medium as recited in claim 12, wherein the step of determining the value comprises dividing a size of the first set by a size of the second set.

16. The computer-readable medium as recited in claim 12, wherein the step of determining the value comprises dividing a size of the first set by a size of the second set and multiplying by a logarithm of the second set.

17. The computer-readable medium as recited in claim 12, wherein the step of presenting the list of ranked search results comprises comparing the value to a threshold value and changing the rank of the at least one web page on whether the value is greater than the threshold value.

18. The computer-readable medium as recited in claim 17, wherein the step of changing the rank comprises removing the at least one web page from the list of ranked search results if the value is greater than the threshold value.

19. The computer-readable medium as recited in claim 17, wherein the step of changing the rank comprises demoting the rank of the at least one web page.

20. The computer-readable medium as recited in claim 17, wherein the step of changing the rank comprises demoting the rank of the at least one web page by an amount proportional to how much the value is greater than the threshold value.

21. A computer-readable medium carrying one or more sequences of instructions for identifying reciprocal links, which instructions, when executed by one or more processors, cause the one or more processors to carry out the steps of:
for each host in a plurality of hosts,
determining, for the each host, a value that is based at least in part on both (a) an intersection of (i) a first set of hosts and (ii) a second set of hosts and (b) a union of (i) a first set of hosts and (ii) the second set of hosts;
associating the each host with the value wherein the step of associating comprises storing the value in a computer-readable medium; and
presenting a list of ranked search results in which a rank of at least one web page that is hosted by the each host is based at least in part on the value associated with the each host and values associated with other hosts in the plurality of hosts.

22. The computer-readable medium as recited in claim 15, wherein the step of presenting the list of ranked search results comprises comparing the value associated with the each host with values associated with other hosts in the plurality of hosts and changing the rank of the at least one web page based on how similar the value associated with the each host is with values associated with other hosts in the plurality of hosts.
